(19) United States
(12) Patent Application Publication
(10) Pub. No.: US 2021/0253360 A1
(43) Pub. Date: Aug. 19, 2021

(54) Return Roller Assemblies for Conveyor Systems

(71) Applicant: UMD Automated Systems, Inc., Fredericktown, OH (US)

(72) Inventor: Don A. Rogers, Fredericktown, OH (US)

(73) Assignee: UMD Automated Systems, Inc., Fredericktown, OH (US)

(21) Appl. No.: 17/172,651

(22) Filed: Feb. 10, 2021

Related U.S. Application Data
(60) Provisional application No. 62/977,424, filed on Feb. 17, 2020.

(51) Int. Cl. B65G 39/07; B65G 39/06

(52) U.S. Cl. CPC B65G 39/07; B65G 39/04; B65G 39/06

(57) ABSTRACT

A return roller assembly for a belted conveyor assembly is formed from an elongated circular roller assembly having ends adapted to affix to a frame assembly and at least one groove around the outside thereof, and at least one circular annular return roller assembly containing a rib about the inside circumference thereof. The elongated circular roller assembly groove is adapted to receive the circular annular return roller rib to retaining the circular annular return roller assembly during rotation of the elongated circular roller assembly.

### CROSS-REFERENCE TO RELATED APPLICATIONS

This application claims benefit of Provisional application 62/977,424 filed Feb. 17, 2020.

### STATEMENT REGARDING FEDERALLY SPONSORED RESEARCH AND DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM

Not applicable.

### STATEMENT REGARDING PRIOR DISCLOSURES BY THE INVENTOR OR A JOINT INVENTOR

Not applicable.

### BACKGROUND OF THE INVENTION

The present disclosure relates to conveyor systems and more particularly to a plastic belt conveyor systems. Roller assembly components of interest are used on a return roller. This assembly is used on bottom side of a conveyer, 12, in FIG. 1, with rollers, such as, for example, a return roller, 14, which will be used herein as typical of all return rollers

The original problem with these return roller assemblies was that, without having some kind of system that locked the donuts in place relative with the roller, the donuts would walk to the left or right over time. Depending on what type of belting was being used, this can create a vibration issue and/or they may completely walk to one side of the roller to where it would rub against the conveyor frame and create premature wear issues on the belt, conveyor frame, and return roller assembly. Vibration also has been a problem.

It is to this issue that the disclosure herein is addressed.

### BRIEF SUMMARY OF THE INVENTION

A return roller assembly for a belted conveyor assembly is formed from an elongated circular roller assembly having ends adapted to affix to a frame assembly and at least one groove around the outside thereof, and at least one circular annular return roller assembly containing a rib about the inside circumference thereof. The elongated circular roller assembly groove is adapted to receive the circular annular return roller rib to retaining the circular annular return roller assembly during rotation of the elongated circular roller assembly.

### BRIEF DESCRIPTION OF THE SEVERAL VIEWS OF THE DRAWINGS

For a fuller understanding of the nature and advantages of the present method and process, reference should be had to the following detailed description taken in connection with the accompanying drawings, in which:

FIG. 1 is a side view of a conveyor showing the return rollers;

FIG. 2 a side prior art return roller 14, as stated above, will be used as typical of all return rollers;

FIG. 3 is a sectional view of prior art return roller 14;

FIG. 4 is an isometric view of the disclosed return roller assembly;

FIG. 5 is a sectional view through the return roller assembly of FIG. 4;

FIG. 6 is a side view of the disclosed return roller assembly of FIG. 4;

FIG. 7 is a sectional view through the return roller assembly of FIG. 6;

FIG. 8 is an isometric view of return roller assembly 28 of FIG. 6;

FIG. 9 is a section view through the return roller of FIG. 8;

FIG. 10 is a side view of the return roller of FIG. 8;

FIG. 11 is a side view of an alternate return roller assembly;

FIG. 12 is a section view through the return roller of FIG. 11;

FIG. 13 is a section view through the return roller of FIG. 11;

FIG. 14 is an isometric view of the return roller of FIG. 11; and

FIG. 15 is a section view through the return roller of FIG. 11.

The drawings will be described in greater detail below.

### DETAILED DESCRIPTION OF THE INVENTION

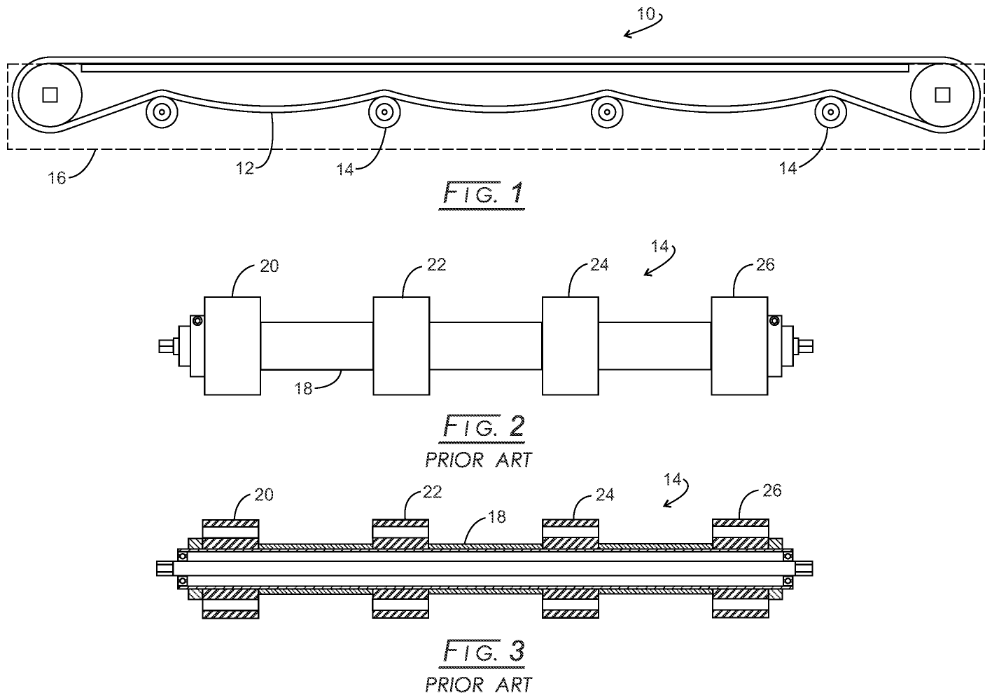

Referring initially to FIG. 1, a conveyor, 10, includes a main frame, 16 shown in phantom, a belt, 12, and return belt rollers as typified by a return roller assembly, 14, such as plastic modular belt conveyors.

Roller assembly 14 is seen in FIG. 2 to consist of a round laterally extending roller tube, pipe or bar, 18, and return rollers, 20, 22, 24, and 26. It should be recognized that a lesser or greater number of return rollers may be used, as is well-known in the conveyor assembly art. The construction of roller tube, pipe or bar 18 can be seen in the cross-sectional view of FIG. 3. Return rollers 20, 22, 24, and 26 are capable of moving laterally, which diminishes their effectiveness and if to one side of roller tube, pipe or bar 18 to where it would rub against the conveyor frame, it would create premature wear issues on the belt, conveyor frame, and return roller assembly.

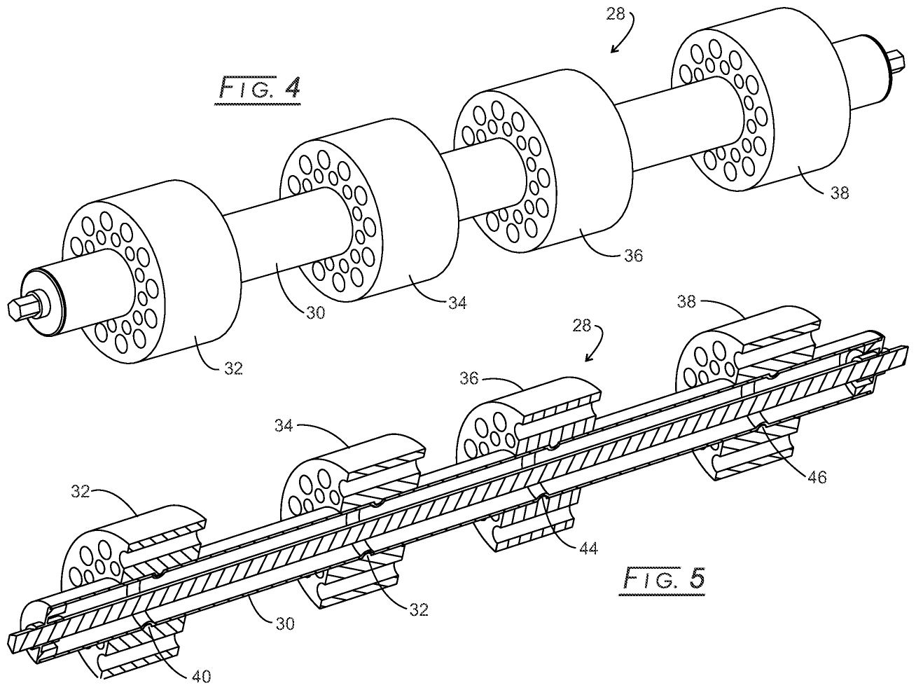

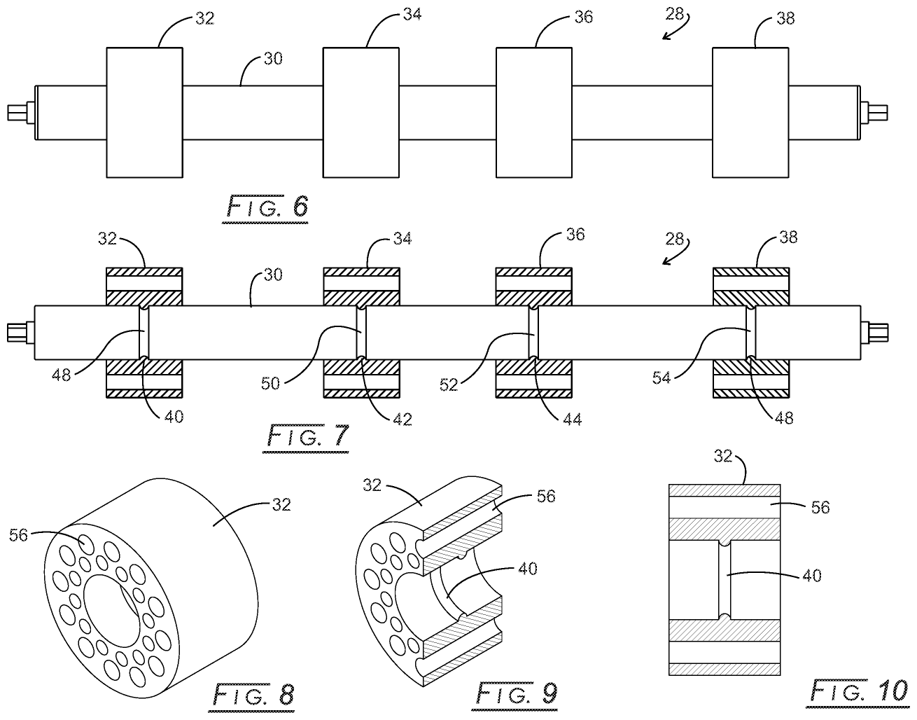

Turning attention to FIGS. 4-10, a disclosed new return roller assembly, 28, including a roller bar assembly, 30, and return rollers, 32, 34, 36, and 38. As can be clearly seen in FIG. 5, the rollers contain an internal hole for receiving return roller assembly 30. Thus, the return rollers are annular in construction. On the inner surface of return rollers 32, 34, 36, and 38, are internal raised ribs, 40, 42, 44, and 46, respectively.

Raised ribs 40, 42, 44, and 46 desirably fit into grooves 48, 50, 52, and 54, (see FIG. 7) in roller assembly 30. By having mating ribs and grooves in the roller assemblies, their migration to either side is substantially lessened if not prevented.

For vibration control for roller tubes, pipes, or bars, 32, 34, 36, and 38, laterally extending holes can be formed into them, such as is illustrated in FIGS. 8-10 fora typical hole, 56.

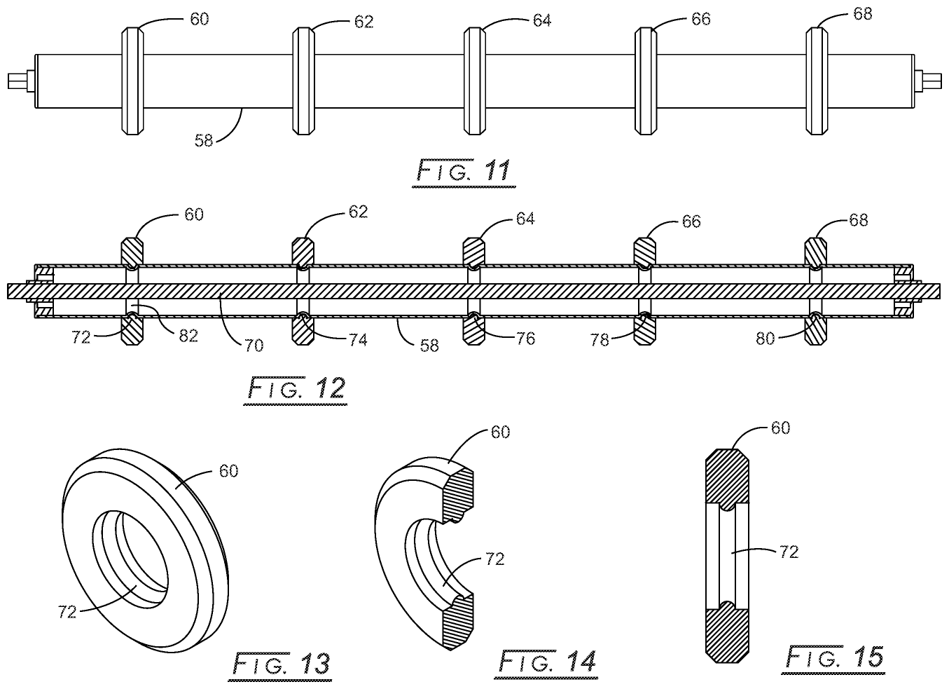

Referring now to FIGS. 11-15, alternative return roller assemblies are illustrated. A central return roller assembly, 58, has return roller assemblies, 60, 62, 64, 66, and 68. Central return roller assembly is shown to be an annulus having a central tube, pipe, rod, 70, running in the annulus for connecting to a frame assembly. These roller assemblies likewise are annular and have internal ribs, 72, 74, 76, 78, and 80, respectively. The return roller internal ribs fit in grooves in the outer surface of return roller assembly 58, as in the first embodiment. This can be easily seen by viewing FIGS. 13-15 where annular return roller 60 with its internal rib 72 is seen to fit into a groove, 82, contained by return roller assembly 58. Rib 7b2 and groove 82 mate for retaining return roller in its designated position and being unable to migrate to either side due to the rotation of return roller assembly 58.

While the device and method have been described with reference to various embodiments, those skilled in the art will understand that various changes may be made and equivalents may be substituted for elements thereof without departing from the scope and essence of the disclosure. In addition, many modifications may be made to adapt a particular situation or material to the teachings of the disclosure without departing from the essential scope thereof. Therefore, it is intended that the disclosure not be limited to the particular embodiments disclosed, but that the disclosure will include all embodiments falling within the scope of the appended claims. Also, all citations referred herein are expressly incorporated herein by reference.

1. A return roller assembly for a belted conveyor assembly, comprising:
(a) an elongated circular roller assembly having ends adapted to affix to a frame assembly and at least one groove around the outside thereof;
(b) at least one circular annular return roller assembly containing a rib about the inside circumference thereof, the elongated circular roller assembly groove adapted to receive the circular annular return roller rib to retaining the circular annular return roller assembly during rotation of the elongated circular roller assembly.

2. The return roller assembly of claim 1, wherein the elongated circular roller assembly contains a plurality of grooves mated with a plurality of circular annular return roller assemblies.

3. The return roller assembly of claim 1, wherein the elongated circular roller assembly is annular.

4. The return roller assembly of claim 1, wherein the return rollers of the return roller assemblies have holes penetrating therethrough for vibration control.

5. A return roller assembly for a belted conveyor assembly, comprising:
(a) an elongated circular roller assembly having ends adapted to affix to a frame assembly and at least one groove around the outside thereof;
(b) at least one circular annular return roller assembly containing holes penetrating therethrough for vibration control.

6. The return roller assembly of claim 5, wherein the elongated circular roller assembly is annular.
